(19) United States
(12) Patent Application Publication
(10) Pub. No.: US 2026/0290012 A1
(43) Pub. Date: Sep. 24, 2026

(54) System and Method for Video Transformation

(71) Applicant: Jeffrey E. Hill, East Otto, NY (US)

(72) Inventor: Jeffrey E. Hill, East Otto, NY (US)

(21) Appl. No.: 19/564,255

(22) Filed: Mar. 12, 2026

Related U.S. Application Data
(60) Provisional application No. 63/771,739, filed on Mar. 14, 2025.

(51) Int. Cl. G06V 20/40; G06V 40/20

(52) U.S. Cl. CPC G06V 20/42; G06V 40/23

(57) ABSTRACT

The disclosed system pertains to the field of 360-degree video editing and manipulation, utilizing an integrated platform leveraging existing software technologies to enhance interactive experiences. The system incorporates functionalities such as zooming, rotating, segment-saving, and drawing within 360-degree video content, facilitated by the Tauri application framework for efficient desktop application performance. The React front-end framework combined with React-Three-Fiber is employed for 3D rendering, providing a user interface analogous to virtual reality environments, enabling advanced video manipulations. Inter-Process Communication (IPC) mechanisms maintain communication between the React interface and the Rust-based backend, supporting seamless session management and system-level task execution. The system demonstrates adaptability across various technological domains, enhancing its applicability beyond 360-degree video contexts.

### CROSS-REFERENCE TO RELATED APPLICATIONS

This application claims priority to U.S. Provisional Patent Application having Ser. No. 63/771,739, filed on Mar. 14, 2025, the entire disclosure of which is hereby incorporated herein by reference.

### BACKGROUND

The field of video editing and manipulation, specifically relating to 360-degree video footage, presents unique challenges due to the inherent complexities of spherical video environments. Traditional video editing tools often lack the capacity to effectively handle the interactive and immersive nature of 360-degree videos, resulting in a significant gap in user experience and functionality. These limitations stem from the static nature of conventional editing suites, which are primarily designed for two-dimensional content and do not inherently support the dynamic interaction required for spherical footage.

Existing technologies in the domain have attempted to address some of these issues, but they generally fall short in providing an all-encompassing solution that integrates both video manipulation and interactive viewing. Many current systems struggle with performance efficiency and user interface design, which are crucial for managing the resource-intensive process of rendering and editing 360-degree content. For instance, most setups do not adequately support the seamless execution of complex tasks like video rotation, zooming, or interactive drawing directly on the video, which are essential for enhancing user interaction within the virtual space.

Furthermore, the architecture of prevalent video editing platforms often lacks the flexibility to manage multiple datasets and complex processing tasks, such as real-time session data management. This results in a cumbersome user experience where switching between video sessions or storing large quantities of editing data can become inefficient and problematic. Additionally, the integration of real-time 3D rendering, necessary for creating immersive environments typical in virtual or augmented reality contexts, is notably absent or undeveloped in current solutions. Most traditional architectures rely heavily on centralized cloud processing, which introduces significant latency and bandwidth bottlenecks when handling high-resolution, omnidirectional media.

What is needed is a comprehensive framework for editing 360-degree videos-a video transformation system-that merges efficient software architecture with advanced user interface capabilities. Such a system would allow users to execute complex video manipulations while maintaining intuitive control over the video environment. This framework should facilitate seamless integration of 3D rendering technologies, interaction mechanisms, and efficient session management to significantly enhance the user's ability to engage with and modify immersive video content.

### FIELD

The present disclosure relates to the field of video editing technology, specifically concerning the manipulation and enhancement of 360-degree video content through the integration of software components such as the Tauri application framework, React, and React-Three-Fiber. This technology leverages these elements to provide comprehensive video manipulation, user interaction, and immersive video editing experiences, with capabilities including video rotation, zooming, drawing, and session management.

### SUMMARY

In one aspect, the present disclosure relates to a video transformation system for editing and manipulating 360-degree video footage, facilitating enhanced interactive experiences through a strategic integration of modular software architectures. The system provides video manipulation logic incorporating zooming, rotating, segment-saving, and drawing functionalities, extending beyond static video capabilities to allow for dynamic user interaction with raw video.

One object of the described technology is to improve the efficiency of 360-degree video manipulation leveraging edge transformation and a lightweight software architecture. This is achieved through a video transformation applicationutilizing the Tauri framework, which facilitates seamless interaction with the operating system for video recording and session data management, ensuring high-performance execution on the user device.

In an embodiment, the system utilizes a web-based front-end framework and React-Three-Fiber for 3D rendering, creating an intuitive user interface that supports spherical navigation within a virtual environment. This configuration enables advanced manipulation of raw video, offering users an immersive experience similar to interacting within a virtual sphere via WebGL rendering.

In another aspect, the system employs Inter-Process Communication (IPC) mechanisms—including WebSockets and command calls—to streamline communication between the user interface and the Rust-based backend. This integration supports system-level task execution and session data management, ensuring synchronized operations and low-latency user experiences when handling multiple video scenes and transformed video outputs.

Yet another objective of this technology is to adapt and expand its application potential, allowing integration into various technological domains such as Virtual Reality (VR), Machine Learning (ML), and computer vision. Through the application of semantic clustering, the system is capable of identifying subjects and objects within a video stream, positioning the architecture for diverse analytics contexts beyond 360-degree video, thus catering to a broad range of high-performance technological requirements.

Furthermore, the system incorporates a video transformation cloud infrastructure comprising a video transformation API and a distributed cloud environment. This infrastructure orchestrates the automated extraction of tagged video segments from a master video library based on rich metadata. By utilizing a hybrid transformation path, the system dynamically allocates processing tasks between the client-side backend and cloud-based containerized instances, optimizing for network latency and computational complexity.

Additionally, the system leverages multimodal neural processing and general purpose vision (GPV) to automate subject identification and behavioral analytics. Through semantic clustering, the system identifies persistent subjects across video frames to define temporal boundaries for automated clipping. This intelligence is integrated with a multi-tenant organizational hierarchy, ensuring that access to specific segments is restricted based on the identified subjects, while simultaneously generating watch receipt telemetry to provide a synchronous audit trail of content consumption.

### BRIEF DESCRIPTION OF THE DRAWINGS

FIG. 1 shows a flowchart illustrating the process of initializing a Tauri application, managing user interactions, and handling data through a series of integrated components including React-Three-Fiber, WebSocket communications, and API calls.

FIG. 2A shows a flowchart depicting an example end-to-end workflow for capturing video segments, generating encoded media, conditionally uploading the media to cloud storage, and providing authorized playback with associated metadata and telemetry.

FIG. 2B shows a block diagram of an authorization and orchestration architecture for delivering entitled video clips from a backend and databases to a mobile viewer application via AWS S3® hosting, including playback requests and watch-receipt telemetry.

FIG. 3 shows a flowchart depicting an example authentication and authorization workflow that conditionally permits access to upload and view resources based on entitlements or denies access.

FIG. 4 shows a flowchart of a video processing workflow in which an input is selectively processed locally or via a cloud computing path to generate a processed output for storage and/or upload.

FIG. 5 shows a flowchart of an example process for entitlement-based access to a media clip, including generating a signed resource locator or token and serving a video asset for playback.

FIG. 6 shows a flowchart of a telemetry-based clip viewing event pipeline in which playback generates view events that are transmitted to an application programming interface, stored in a database view log, and made available for reporting and oversight via an administrative portal.

FIG. 7 shows a flowchart of selecting a delivery mode for an encoded MP4 file to provide either direct download playback or HLS streaming via segmentation into chunks and progressive client requests.

### DETAILED DESCRIPTION

### Definitions and Terminology

As used herein, the following terms shall have the meanings ascribed to them below unless the context clearly dictates otherwise. The terminology used in the present disclosure is for the purpose of describing particular embodiments only and is not intended to be limiting.

It is to be understood that the use of specific software frameworks (e.g., FastAPI, Tauri, React, Rust) or hardware standards (e.g., AWS S3®, WebGL) are intended to describe preferred embodiments; however, one of ordinary skill in the art will recognize that functionally equivalent frameworks, languages, or storage architectures may be substituted without departing from the spirit and scope of the invention.

Furthermore, the terms “comprising,” “including,” and “having” are used interchangeably and are intended to be open-ended, meaning that items other than those listed may also be present. References to “a” or “an” are intended to include both the singular and the plural forms, unless the context specifically indicates a single instance.

Video Transformation System: As used herein, the term “video transformation system” refers to the integrated hardware and software architecture—comprising cloud infrastructure and client-side applications—facilitating the capture, storage, identification, and manipulation of video data.

Video Cloud Storage: Refers to a remote, scalable data storage environment, preferably AWS S3®, configured to house the master video library and associated transformed assets within a secure, high-availability infrastructure.

Video Database: Refers to a structured data store (e.g., PostgreSQL, MongoDB, or similar) within the video transformation cloud infrastructure that maintains relational mappings between raw videos, user identifiers, organizational entitlements, and the synchronous access record.

Master Video Library: Refers to a centralized repository within the video cloud storage containing the primary, high-resolution raw videos from which tagged video segments and transformed videos are derived.

Video Transformation Cloud Infrastructure: Refers to the collective server-side environment, including the video transformation API, video database, and cloud storage, that orchestrates remote processing, authentication, and data delivery.

Video Transformation API: Refers to a programmed interface, preferably implemented using the FastAPI framework, that facilitates communication between a client-side application and a cloud-based backend. The API serves as an orchestration layer for data retrieval, user authentication (AuthN), entitlement enforcement (AuthZ), and the triggering of remote processing scripts.

Raw Video: Refers to unedited or minimally processed video data uploaded to the cloud repository. This includes, but is not limited to, video captured via WebGL-based protocols, digital sensors, or mobile devices.

Tagged Video Segment: Refers to a discrete temporal portion of a raw video file that has been isolated based on associated metadata or subject identification.

Video Manipulation Logic: Refers to the specific computational instructions—whether executed via the Rust-based backend or cloud-based neural processing—that modify a video file, including but not limited to adding telestrations, 3D overlays, semantic cropping, or metadata embedding.

Transformed Video: Refers to a media file generated by applying video manipulation logic to a raw video or tagged video segment, resulting in a version that includes visual, temporal, or metadata enhancements.

Video Transformation Application: Refers to the client-side software package, preferably utilizing the Tauri framework, used by a user to capture raw video, input processing parameters, and initiate video manipulation logic.

Video Viewing Application: Refers to a client-side interface (e.g., a mobile app or web portal) specifically configured for the authenticated retrieval, playback, and telemetry-logging of entitled video clips.

Semantic Clustering: Refers to the application of artificial intelligence and machine learning algorithms to identify, categorize, and isolate specific objects or subjects (e.g., individual sports players) within a video stream based on visual or contextual characteristics.

Tauri Framework: Refers to a cross-platform application construction toolkit that enables the execution of web-based front-end technologies (e.g., HTML, CSS, JavaScript) within a native OS window, while leveraging a Rust-basedbackend for low-level system access and high-performance computational tasks.

Edge Transformation/Local Processing: Refers to the execution of video manipulation logic (e.g., via FFmpeg or GStreamer) on the hardware of the user's device rather than on a remote server, thereby reducing server-side computational load and network latency.

Synchronous Access Record: Refers to a non-volatile log or metadata entry within a database that tracks the state of a user's interaction with a specific media asset, providing a verifiable “read receipt” or audit trail of content consumption.

Multi-Tenant Organizational Hierarchy: Refers to a database and system architecture that logically isolates data (e.g., videos, user logs, and credentials) belonging to distinct entities—including, but not limited to, schools, youth leagues, and sports teams—while allowing administrative oversight within each specific entity.

Keyframes and Delta Events: Refers to the constituent components of a reconstructed video stream. Keyframesrepresent full-frame data, while delta events represent incremental temporal changes between keyframes, which are utilized by the Rust-based backend to reconstruct or replay a video sequence.

Hybrid Transformation Path: Refers to a system logic that dynamically selects between edge transformation (local processing) and cloud-based neural processing based on environmental factors, including network latency, hardware availability, or model complexity.

Watch Receipt Telemetry: Refers to a stream of metadata events (e.g., “opened,” “started,” “progress,” and “completed” status) emitted by a client-side application to the video transformation API to populate the synchronous access record.

Pre-signed URL/Secure Token: Refers to a time-limited, cryptographically signed access string generated by the video transformation API that grants the video viewing application temporary, direct access to a specific object within the video cloud storage.

Multimodal Neural Processing: Refers to an artificial intelligence architecture capable of processing multiple types of data inputs—such as video frames, audio, and text—simultaneously to perform high-level reasoning or object identification.

General Purpose Vision (GPV): Refers to computer vision logic that can identify and analyze objects or actions without being restricted to a single predefined category, allowing for the detection of varied athletic movements and equipment trajectories.

Temporal Boundary: Refers to the specific start and end timestamps within a raw video file that define the duration of a tagged video segment.

Cloud-Based Video Repository and Database Architecture

In one embodiment, a video transformation system is disclosed, wherein the system includes video transformation cloud infrastructure that includes video cloud storage, a video database, and a video transformation API. The video cloud storage includes a master video library having raw videos that have been uploaded by a user (either by live stream options, in particular by HTTP Live streaming (HLS), or by MP4 uploads). In preferred embodiments, the video is recorded using WebGL which is a graphics programming language. In preferred embodiments, the video transformation cloud infrastructure is housed in AWS S3® cloud storage.

### Server-Side Segmentation and Media Extraction

The video transformation API is capable of querying a video database to retrieve metadata associated with a raw video located in the master video library of the video cloud storage. The video transformation API facilitates the creation of a tagged video segment via a video processing engine or media transformer, which extracts the tagged video segment from the raw video and saves it to the video cloud storage for delivery to the user device. in a preferred embodiment, the video transformation API is implemented using the FastAPI framework.

### Preferred Cloud Computing Environment

In particular, the video transformation cloud infrastructure triggers logic, preferably a Python® script, that utilizes a multimedia framework to pull the raw video from the video cloud storage and extracts a specific segment based on metadata. The multimedia framework segments the raw video, saves the resulting file (a tagged video segment) to the video cloud storage, and provides a reference to the video transformation API, which then facilitates the delivery of the tagged video segment to a user's device for review, preferably by way of a pre-signed url.

### Client-Side Application Architecture (Tauri Framework)

The system further includes a video transformation application that sits on a user's device. The video transformation application is a unified software package comprising a Tauri framework with a web-based user interface and a Rust-based backend. Within this unified package is an integrated video viewing module capable of playing raw video, tagged video segments, and transformed video. In preferred embodiments, the video viewing module utilizes WebGL for high-performance rendering of video content and associated metadata overlays. A user provides processing parameters through the Tauri UI to select or review video content via the video transformation API.

### Distributed Processing and Edge Transformation

When processing parameters are given, the Rust backend manages the API communication to fetch the required video data, which is then processed locally. The Rust backend initiates Rust logic to facilitate FFmpeg or GStreamer to manipulate the tagged video segments, creating a transformed video that can be reviewed in the viewing module and subsequently stored locally or transmitted back to the video cloud storage via the video transformation API for remote storage. In preferred embodiments, manipulation of the tagged video segment is done by way of neural processing using AI semantic video technology. In more preferred embodiments, the VL (video language) or the neural processing involves a multimodal model (e.g., Gemini). In other preferred embodiments, manipulation of the tagged video segments includes, but is not limited to, converting the tagged video segments into transformed videos that have 3D, added telestration, and/or added illustration.

The software to manipulate the tagged video segments, including computer vision and neural processing and general purpose vision (gpv), will be housed in the video transformation cloud infrastructure, In other embodiments, it is possible that this software will be housed locally on a user's device.

The system utilizes a multimodal neural processing model (e.g., Gemini) to execute General Purpose Vision (GPV)tasks. This allows the system to analyze tagged video segments to detect athletic movements, such as a player's skating stride, or object trajectories, such as the speed of a hockey puck. Based on these detections, the system populates custom analytics fields within a telemetry log. Furthermore, the video manipulation logic synchronizes 3D coordinate overlays(such as telestrations or 3D markers) with the metadata via the WebGL renderer. These overlays are ‘anchored’ to the identified subject, meaning they persist in the correct spatial orientation even as the subject moves or the 360-degree camera view is rotated.

### Integrated Video Playback and Review Module

In some embodiments, the system is configured to manage user-specific access, wherein specific users are permitted to view only the tagged video segments in which they are identified. The video transformation API facilitates this by filtering video metadata to associate individual players with specific video segments. For example, in a sports application, such as a hockey setting, a player may utilize the system to review their specific performance. The system utilizes the aforementioned video transformation API and database architecture to ensure that a tagged user is granted access only to their respective segments. However, it is noted that the system is not limited to sports or hockey and may be utilized in any suitable environment requiring the identification, segmentation, and transformation of video data for specific users.

In some embodiments, the system incorporates a natural language query interface to facilitate user interaction with the video database and metadata. While any suitable natural language processing (NLP) engine may be utilized, preferred embodiments may implement HCL's Augmented Network Automation (ANA®). This interface allows users to perform complex data retrieval and analysis through natural language queries, further enhancing the accessibility of the video transformation system.

### Additional System Features and User Management

### User Authentication and Organizational Hierarchy

In some embodiments, the video transformation API, implements an authentication layer requiring user-defined credentials (e.g., a password) to grant access to the video cloud infrastructure. This authentication enables a multi-tenant hierarchy where organizations—including, but not limited to, schools, youth leagues, and sports teams—manage groups of users. The system is further characterized as an invite-only application, restricted to specific devices to ensure a secure, closed-loop environment.

### Administrative Oversight and Usage Tracking

The video transformation API further provides an administrative employee portal designed for system oversight. This portal allows authorized employees to monitor usage metrics at both the individual user level and the organizational level. To facilitate transparency and accountability, the system implements a synchronous access record (analogous to a read-receipt). This record tracks user engagement by logging which raw videos or tagged video segments have been accessed, viewed, or downloaded by a specific user.

### AI-Enhanced Semantic Clustering and Subject Identification

To facilitate the precise delivery of content, the system utilizes artificial intelligence to perform semantic clustering. This process involves the automated identification and isolation of specific individuals within a video stream. By separating subjects from the background or from other players, the system generates metadata that the video transformation uses to determine which users are permitted to view specific segments. For example, a player (such as a hockey player) is granted access to view a tagged video segment only if the semantic clustering logic has identified them within that specific segment. Both the raw video and the isolated tagged segments remain available for further manipulation within the unified video transformation application. In some embodiments, the user's device will include an analytics system that creates a spreadsheet with custom analytics fields and the user will be able to see the analytics.

The present disclosure relates to a system and method for interactive manipulation of 360-degree video footage leveraging integrated software technologies. The described system comprises a combination of software components facilitating advanced video editing functionalities that enhance user interaction and experience with immersive video content.

The system utilizes the Tauri application framework to construct lightweight desktop applications. Tauri's ability to efficiently engage with the underlying operating system is pivotal, as it manages tasks associated with video recording and manipulation. The framework supports a Rust-based backend which handles the core processing and data management functionalities, ensuring robust application performance across various operating conditions.

The front-end of the system is implemented using React, a JavaScript library that manages the user interface state. React is augmented by React-Three-Fiber, a library designed for rendering 3D graphics within a React environment using WebGL. This configuration allows for seamless manipulation of 360-degree video content, providing users with an interface that simulates virtual reality environments through a spherical video representation. The immersive interface enables functionalities such as video rotation, zooming, segment-saving, and interactive drawing directly on the video content.

Inter-process communication (IPC) is enabled between the React interface and the backend using WebSocket connections. This mechanism ensures efficient data transfer and command execution between the user interface and the system's core processes. IPC facilitates tasks such as initiating video recording, handling user commands, and managing session-specific data across different video editing sessions.

Session management is an integral feature of the system, allowing users to maintain control over different video editing tasks. A sessions window within the application interface permits users to store, switch, and retrieve session-specific data efficiently. This capability is enabled by invoking API calls, which interact with the backend to save modifications, manage multiple video scenes, and handle extensive editing data.

Adaptability across various footage types and applications is an additional feature of this system. Although primarily designed for 360-degree video content, the architecture is inherently flexible, supporting integration within domains such as Virtual Reality (VR), Machine Learning (ML), and computer vision applications. The versatility of the technology stack affirms its applicability beyond conventional 360-degree video editing, catering to a broader array of technological requirements and user needs.

The described disclosure outlines a sophisticated framework, wherein each component of the system is interconnected to enable a cohesive and enhanced video editing experience, marked by intuitive control and interaction capabilities. The seamless integration of these technological elements distinguishes the system in providing an innovative approach to handling and interacting with 360-degree video footage.

In one embodiment, the system and method may be used in an athletic training context, including, but not limited to hockey training. The system and method may be use in combination with a 360-degree camera mount that is used to obtain footage of an athlete. It is understood that the description of the camera mount in a hockey arena setting in no way limits what type of context the camera mount may be used. The camera mount may be used in any setting where a 360-degree camera is desirable.

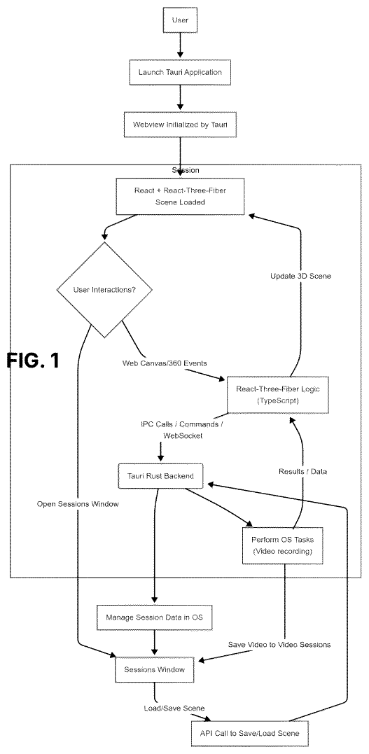

FIG. 1 illustrates a flowchart depicting the operational logic of the video transformation application for the editing and manipulation of 360-degree video footage. The process initiates with the user launching the application via the Tauri framework. Upon activation, a webview is initialized to facilitate the front-end environment.

Following initialization, a 3D scene comprising React and React-Three-Fiber is loaded, establishing a platform for immersive interaction. The system processes user input to handle Web Canvas or 360-degree events. This path leads to the execution of React-Three-Fiber logic (e.g., utilizing TypeScript), which updates the 3D scene and WebGL rendering based on real-time input data.

The system architecture integrates inter-process communication (IPC) through command calls and WebSocket connections to bridge the front-end interface with the Rust-based backend. This interaction enables high-performance execution of operating system tasks, such as the recording and processing of raw video. Captured data is subsequently saved to video sessions within the video database and video cloud storage, ensuring secure capture and subsequent retrieval.

Through a sessions window, users may manage session data stored within the operating system. Users can load or save scenes via the video transformation API, providing seamless access to session data and the master video library. This comprehensive flow ensures continuous user interaction with 360-degree video content, enabling advanced editing and video manipulation logic.

In some embodiments, the system performs semantic clustering utilizing computer vision models (e.g., YOLOv8 or Convolutional Neural Networks) for the detection of players, motion analysis, and object speed measurement (e.g., a volleyball or a hockey puck). The system may display visual representations—such as bounding boxes or segmented images—contingent upon specific detection parameters. For example, a user may “select” a player identified by a specific jersey number to access additional metadata retrieved via the video transformation API.

In certain embodiments, the system utilizes a cloud-based session management system to enable cross-device synchronization and may further include end-to-end encryption or support for Virtual Reality (VR) peripherals to enhance the immersive editing experience.

### Data Capture, Local Reconstruction, and Cloud Synchronization

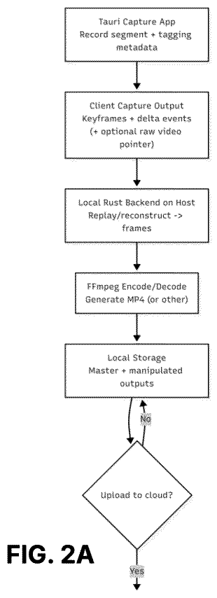

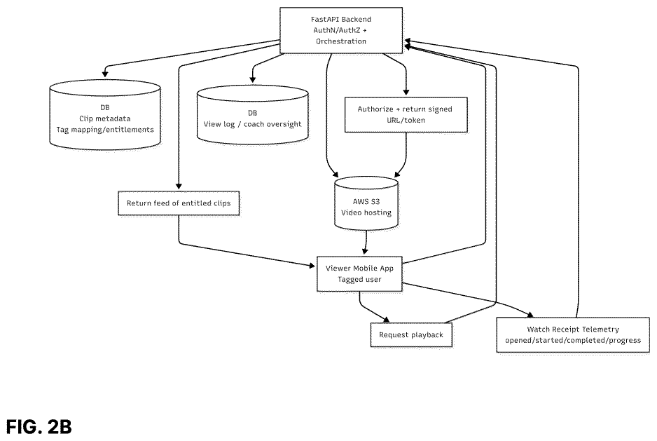

The system further implements a multi-stage processing and delivery workflow, as illustrated in FIG. 2A and FIG. 2B. In one embodiment, the video transformation application (referred to as the Tauri Capture App) initiates a recording session to generate raw video and associated metadata. During this session, the application records discrete keyframes and delta events—representing temporal changes in the video stream—which are combined with tagging metadata to form a client capture output.

### Local Backend Reconstruction and Encoding

The client capture output is processed by the Rust-based backend residing on the host device. The Rust logic performs a replay and reconstruction operation, transforming the keyframes and delta events into a sequence of reconstructed frames. These frames are then interfaced with a multimedia framework, such as FFmpeg, to perform encoding and decoding tasks. This process generates standardized media files (e.g., MP4) which are stored in local storage as both a master record and as manipulated outputs (i.e., transformed video).

### Cloud Orchestration and Secure Delivery

The system includes a decision logic to determine if the local content should be synchronized with the video transformation cloud infrastructure. Upon a trigger to upload:

Orchestration and Authentication: The Video Transformation API (FastAPI backend) manages the transmission, providing an Authentication and Authorization (AuthN/AuthZ) layer to ensure secure data handling. Database Integration: The API interacts with the video database, which is partitioned to store clip metadata(including tag mapping and user entitlements) and a separate synchronous access record (view log) for administrative or coaching oversight. Secure Hosting: Validated content is committed to video cloud storage (specifically AWS S3®). To ensure secure delivery, the API executes an authorization operation that generates a pre-signed URL or secure token.

### User-specific Distribution and Telemetry

The system provides a video viewing application (e.g., a Viewer Mobile App) for a tagged user. This application queries the video transformation API to receive a filtered feed of entitled clips.

Authenticated Playback: Using the pre-signed URL/token, the viewing application requests playback directly from the cloud repository. Consumption Tracking: To maintain the synchronous access record, the viewing application generates watch receipt telemetry. This telemetry data includes specific engagement metrics—such as whether a video was opened, started, completed, or the specific duration of progress—which is transmitted back to the Video Transformation API to update the audit trail and coach oversight logs in the video database.

### Organizational Multi-tenancy and Access Control

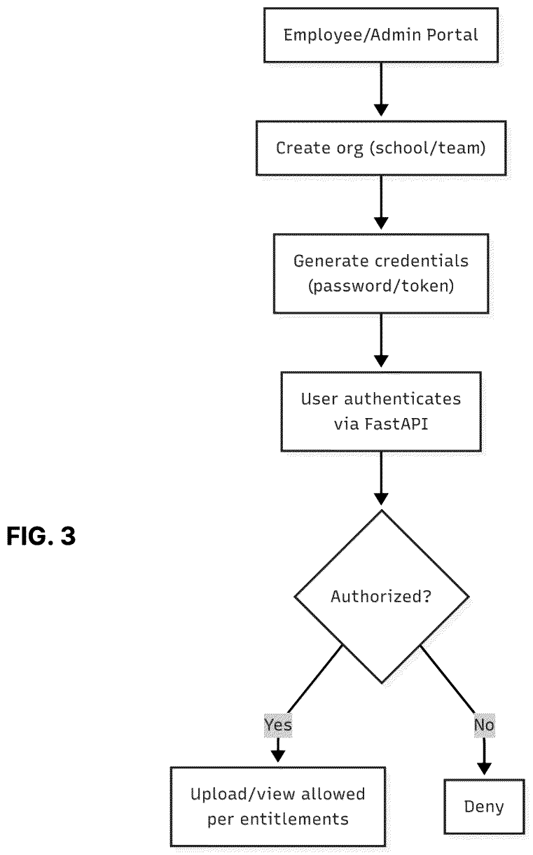

FIG. 3 illustrates the process flows for establishing a secure, multi-tenant hierarchy within the video transformation system.

Administrative Onboarding: An administrative employee portal receives an interaction to define an organization (e.g., a school or sports team). Responsive to this, the video transformation cloud infrastructure performs a credential generation operation, producing authentication artifacts such as passwords or tokens. Authentication Layer: A user attempts to access the system by authenticating via the video transformation API(FastAPI framework). Authorization Logic: Following authentication, a decision operation determines if the user is authorized based on stored roles or organizational membership. If the decision yields a positive result, the system enables the user to upload or view content according to their specific entitlements. If negative, the system executes a deny operation, maintaining the secure, closed-loop environment of the application.

### Hybrid Edge and Cloud Transformation Logic

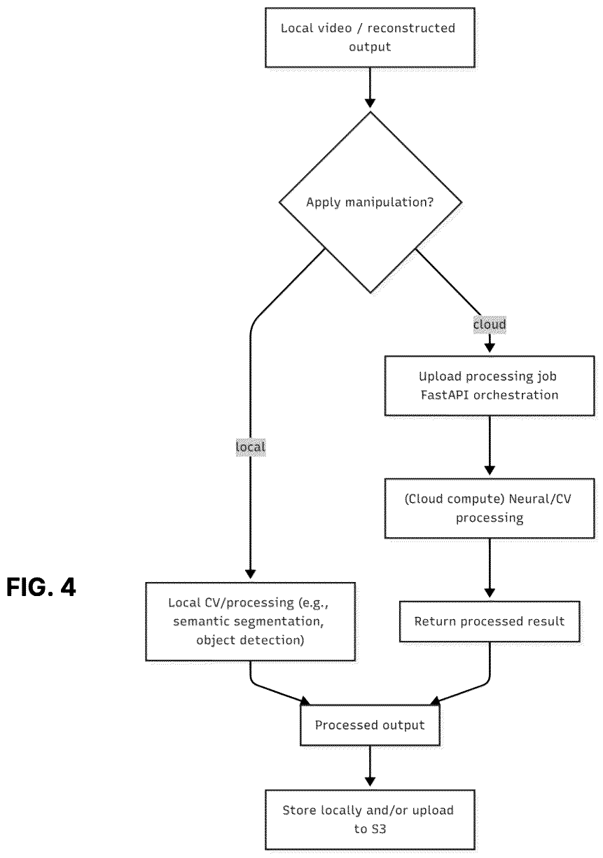

FIG. 4 depicts a processing flow for the manipulation of video data, providing a selection between local processing and cloud-based computation.

Path Selection: Once a raw video or reconstructed output is available, the system determines whether to apply manipulation via a Local Path or a Cloud Path. This selection may be based on latency, bandwidth, or the complexity of the required neural processing. Local Path (Edge Transformation): The flow proceeds to local computer vision (CV) processing—such as semantic clustering or object detection—executed via the Rust-based backend on the user's device. Cloud Path: The video transformation API orchestrates a processing job within the video transformation cloud infrastructure, where high-performance neural/CV processing (e.g., via a multimodal model like Gemini) is performed. Result Consolidation: Both paths culminate in a processed output (e.g., transformed video, telestrations, or metadata embeddings), which is then saved to the video cloud storage (AWS S3®) or retained in local storage.

### Entitlement-based Media Retrieval

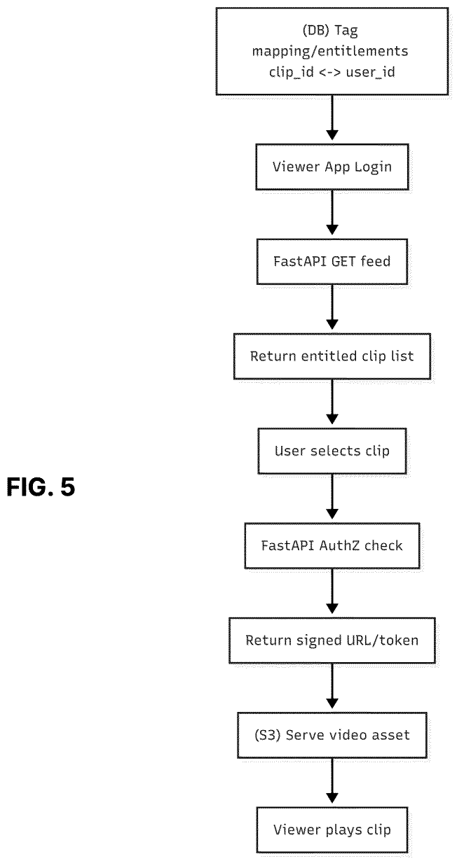

FIG. 5 illustrates the mechanism for controlling access to tagged video segments based on the association between user identifiers and clip identifiers within the video database.

Data Mapping: The database maintains a tag mapping (clip_id <->user_id) which dictates which users are permitted to view specific segments identified through semantic clustering. Request Pipeline: A user logs into the video viewing application, which issues a GET request to the video transformation API. The API queries the database to return an entitled clip list, ensuring a player sees only the segments where they have been identified. Secure Delivery: Upon selecting a clip, the API performs an authorization check and returns a pre-signed URL. This allows the viewing application to securely retrieve and play the asset directly from the video cloud storage.

### Telemetry and Synchronous Access Recording

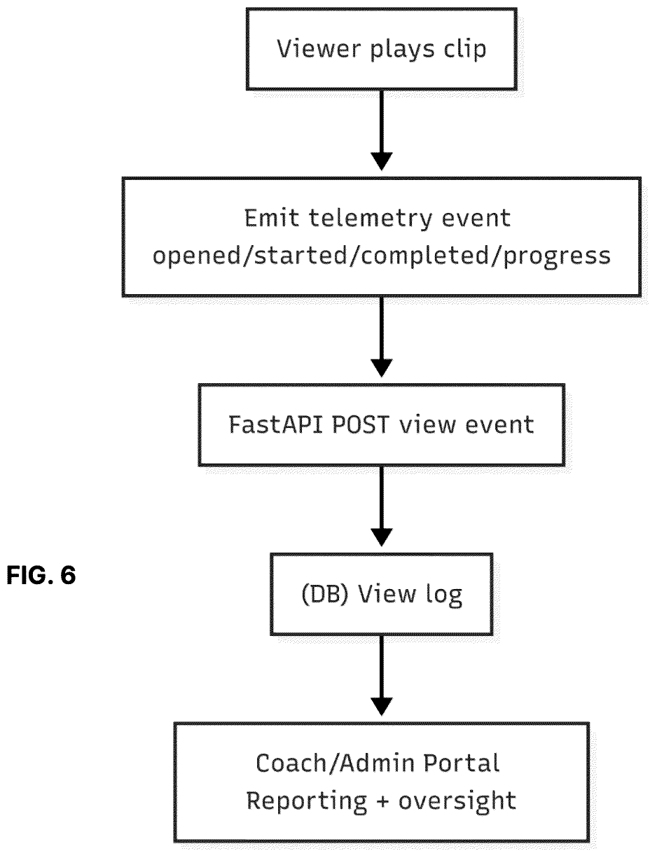

FIG. 6 illustrates the generation of a synchronous access record to provide administrative oversight of content consumption.

Lifecycle Telemetry: As a user engages with a clip, the video viewing application emits telemetry events corresponding to the playback state (e.g., opened, started, progress milestones, and completed). Audit Trail: These events are transmitted via a POST request to the video transformation API, which writes the records to a view log within the video database. Administrative Oversight: Authorized personnel can access this log via the administrative portal to monitor usage metrics, completion rates, and progress distributions, thereby ensuring a verifiable audit trail of how tagged video segments are being reviewed by users or athletes.

### Delivery Mode

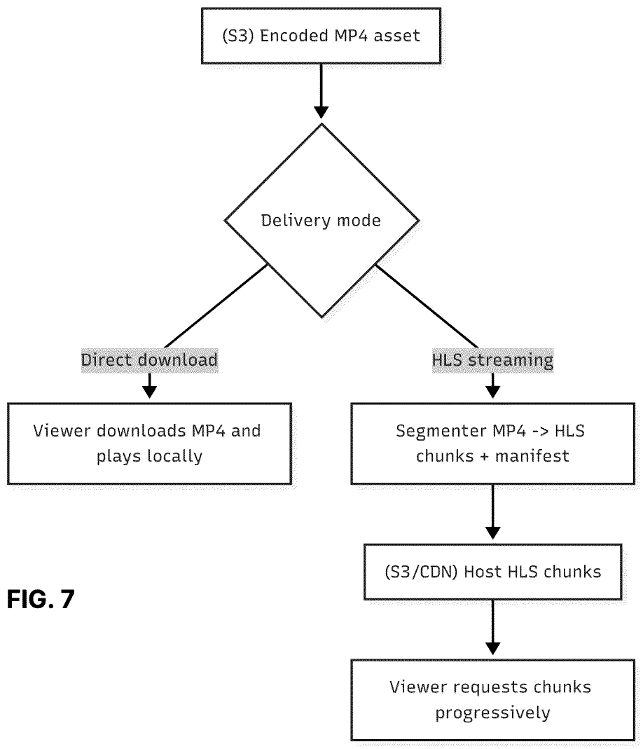

FIG. 7 shows a flow diagram for selecting a delivery mode for an encoded MP4 asset stored in a storage service (S3). The delivery mode may branch between a direct download path and an HTTP Live Streaming (HLS) streaming path based on one or more delivery criteria, such as a client capability indicating support for HLS playback, a network condition, a content policy, or a requested playback mode.

In the direct download path, a viewer device issues a request for the MP4 asset and receives the MP4 asset for local storage at the viewer device. The viewer device plays the MP4 asset locally using a media player executing on the viewer device, which may include buffering a portion of the MP4 asset before initiating playback.

In the HLS streaming path, a segmenter transforms the MP4 asset into a plurality of HLS media segments (HLS chunks) and generates an HLS playlist (manifest) that references the plurality of HLS media segments. The HLS media segments and the HLS playlist are stored and hosted via (S3/CDN) for access by viewer devices. The viewer device requests the HLS playlist, parses the HLS playlist to obtain references to the HLS media segments, and issues successive requests for the HLS media segments in a progressive manner. The viewer device buffers received HLS media segments and plays the content by decoding buffered segments while additional segments are requested and received from the hosted HLS chunks.

It will be appreciated by those skilled in the art that while the system and method for interactive 360-degree Video manipulation using integrated software technologies has been described in detail herein, the invention is not necessarily so limited and other examples, embodiments, uses, modifications, and departures from the embodiments, examples, uses, and modifications may be made without departing from the process and all such embodiments are intended to be within the scope and spirit of the appended claims.

1. A computer-implemented method comprising the steps of:
a. receiving, by a video cloud storage, a raw video for storage in a master video library;
b. receiving, by a video database, metadata associated with the raw video;
c. receiving, by a video transformation API, a request for a tagged video segment;
d. querying, by the video transformation API, the metadata from the video database;
e. initiating, via the video transformation API, a video processing engine or a media transformer within a video transformation cloud infrastructure;
f. triggering, by the video processing engine or the media transformer, a logic script to retrieve the raw video from the video cloud storage;
g. extracting, via a multimedia framework managed by the logic script, a tagged video segment from the raw video based on the metadata;
h. saving the tagged video segment to the video cloud storage; and
i. generating, via the video transformation API, a reference to the tagged video segment for delivery to a user device.

2. The computer-implemented method of claim 1, wherein the raw video comprises 360-degree video footage represented in a spherical projection, wherein the tagged video segment corresponds to a temporally delimited portion of the raw video, and wherein the request for the tagged video segment is received from a video transformation application executing on the user device, the video transformation application comprising a desktop application constructed using a Tauri application framework.

3. The computer-implemented method of claim 1, further comprising rendering, by a front-end user interface of the video transformation application, the raw video or the tagged video segment as a navigable spherical scene using a WebGL renderer, wherein the rendering is performed using React and React-Three-Fiber to maintain user interface state and to drive the WebGL renderer.

4. The method of claim 1, further comprising: receiving, at the video transformation application, a user interaction specifying at least one manipulation parameter comprising a zoom parameter, a rotation parameter, a drawing parameter, or a segment-save parameter; and persisting said at least one parameter as a session record in a local sessions window, enabling the video transformation application to retrieve and re-apply the manipulation parameters to the raw video across different viewing sessions.

5. The method of claim 1, further comprising: organizing a plurality of user identifiers into a multi-tenant organizational hierarchy within the video database; and generating a synchronous access record by capturing watch receipt telemetry from the user device, wherein said telemetry is logically isolated within the hierarchy to provide administrative oversight of content consumption for a specific organization.

6. The computer-implemented method of claim 1, further comprising communicating between a front-end interface and a client-side backend using inter-process communication (IPC) comprising at least one of a WebSocket channel or a command call to execute at least one system-level task associated with the user interaction.

7. The computer-implemented method of claim 1, wherein the metadata comprises at least one of a tag mapping between a clip identifier and a user identifier, a timecode range, a frame index range, an object identifier, or a scene identifier, and wherein extracting the tagged video segment is performed according to the metadata.

8. The computer-implemented method of claim 1, wherein extracting the tagged video segment comprises performing, by the multimedia framework, a temporal trim operation that copies encoded frames without re-encoding to isolate the tagged video segment.

9. The computer-implemented method of claim 1, further comprising transcoding, by the multimedia framework, the tagged video segment into a plurality of encodes having respective bitrates, resolutions, or codecs, and saving the plurality of encodes to the video cloud storage.

10. The computer-implemented method of claim 1, wherein generating the reference comprises generating a pre-signed Uniform Resource Locator (URL) that is time-limited and that authorizes direct retrieval from the video cloud storage without proxying the tagged video segment through the video transformation API.

11. The computer-implemented method of claim 1, wherein initiating the video processing engine or the media transformer comprises instantiating a containerized processing instance within a distributed cloud environment to execute the logic script.

12. The method of claim 1, further comprising: reconstructing, by a client-side backend on the user device, a sequence of frames for the raw video based on keyframes and delta events captured during a recording session; and encoding, by a multimedia framework interfaced with the client-side backend, the reconstructed frames into a standardized media file prior to uploading the raw video to the master video library.

13. The method of claim 1, further comprising utilizing video manipulation logic via a multimodal neural processing model to perform general purpose vision (GPV) tasks, comprising: analyzing the tagged video segment to detect specific athletic movements or object trajectories (e.g., puck or ball speed); and generating custom analytics fields within a synchronized telemetry log based on the detected movements.

14. The method of claim 3, further comprising applying video manipulation logic to the tagged video segment to generate a transformed video by synchronizing a 3D coordinate overlay with the metadata, wherein the 3D coordinate overlay is rendered via a WebGL renderer and comprises at least one of: a telestration, a semantic crop, or an embedded metadata track that persists relative to a subject identified in the tagged video segment.

15. The method of claim 1, wherein the metadata is generated by an artificial intelligence model executing a semantic clustering operation that: (i) identifies a persistent subject across a plurality of frames in the raw video; (ii) calculates a temporal boundary for the tagged video segment based on the subject's activity; and (iii) maps the identified subject to a specific user identifier to authorize the request for the tagged video segment.

16. A system for video transformation and delivery, the system comprising:
j. at least one processor and a memory storing instructions that, when executed by the at least one processor, cause the system to provide:
k. a video database configured to store metadata associated with a raw video;
l. a video cloud storage configured to store the raw video in a master video library;
m. a video transformation API configured to receive a request for a tagged video segment and query the metadata from the video database; and
n. a video transformation cloud infrastructure comprising a video processing engine or a media transformer;
o. wherein the video transformation API is configured to initiate the video processing engine or the media transformer in response to the request;
p. wherein the video processing engine or the media transformer is configured to trigger a logic script to retrieve the raw video from the video cloud storage and extract, via a multimedia framework managed by the logic script, a tagged video segment from the raw video based on the metadata;
q. wherein the system is further configured to save the tagged video segment to the video cloud storage; and
r. wherein the video transformation API is further configured to generate a reference to the tagged video segment for delivery to a user device.

17. The system of claim 16, wherein the metadata associated with the raw video comprises at least one of a timestamp, a frame index, a scene description, or a unique identifier for an object detected within the raw video, and wherein the system further comprises an artificial intelligence (AI) engine configured to identify a plurality of objects within the raw video and generate the metadata based on the identified plurality of objects prior to the metadata being stored in the video database, and wherein the video processing engine or the media transformer is configured to perform a lossless trim of the raw video via the multimedia framework to isolate a temporal segment defined by the metadata, and wherein a reference to the tagged video segment generated by the video transformation API comprises a Uniform Resource Locator (URL) containing an authentication token for temporary access to the video cloud storage, and wherein the video transformation cloud infrastructure is configured to spin up a containerized instance of the video processing engine or the media transformer in response to a request for the tagged video segment, and wherein the media transformer is further configured to transcode the tagged video segment into a plurality of bitrates or resolutions prior to the video transformation API generating the reference for delivery to the user device.

18. A non-transitory computer-readable medium storing instructions that, when executed at least one processor, cause the at least one processor to perform operations comprising:
s. receiving, by a video cloud storage, a raw video for storage in a master video library;
t. receiving, by a video database, metadata associated with the raw video;
u. receiving, by a video transformation API, a request for a tagged video segment;
v. querying, by the video transformation API, the metadata from the video database;
w. initiating, via the video transformation API, a video processing engine or a media transformer within a video transformation cloud infrastructure;
x. triggering, by the video processing engine or the media transformer, a logic script to retrieve the raw video from the video cloud storage;
y. extracting, via a multimedia framework managed by the logic script, a tagged video segment from the raw video based on the metadata;
z. saving the tagged video segment to the video cloud storage; and
aa. generating, via the video transformation API, a reference to the tagged video segment for delivery to a user device.

19. The non-transitory computer-readable medium of claim 18, wherein the metadata associated with the raw video comprises at least one of a timestamp, a frame index, a scene description, or a unique identifier for an object detected within the raw video, wherein the non-transitory computer-readable medium further stores instructions that, when executed by the at least one processor, cause the at least one processors to perform operations comprising identifying, via an artificial intelligence (AI) model, a plurality of objects within the raw video, generating the metadata based on the identified plurality of objects prior to receiving the metadata by the video database, extracting the tagged video segment by performing a lossless trim of the raw video via the multimedia framework to isolate a temporal segment defined by the metadata, providing the reference to the tagged video segment as a Uniform Resource Locator (URL) containing an authentication token for temporary access to the video cloud storage, and instantiating a containerized version of the video processing engine or the media transformer within a distributed cloud environment in response to the request for the tagged video segment.
